(19) United States
(12) Patent Application Publication
(10) Pub. No.: US 2018/0029478 A1
(43) Pub. Date: Feb. 1, 2018

(54) Automobile motion electric generator

(71) Applicant: Larry W. Peterson, Middletown, OH (US)

(72) Inventor: Larry W. Peterson, Middletown, OH (US)

(73) Assignee: Larry W. Peterson, Middletown, OH (US)

(21) Appl. No.: 14/999,672

(22) Filed: May 27, 2016

(51) Int. Cl. B60L 8/00

(52) U.S. Cl. CPC B60L 8/006

(57) ABSTRACT

Air motion generators are mounted on automobile to capture energy from the movement of air from hoods contained fan/electrical producing mechanism. Each hood contain two or more electrical producing mechanisms and one or more fans. The electricity produced by the electrical producing mechanism is stored in a battery for use to power the automobile.

### FIELD OF INVENTION

The invention is concerned with auxiliary generators to recharge batteries of either electric or hybrid electric cars. The generators will generate electricity when air moves through fans as the automobile moves or during breaking. In particular the present invention has fan generators on the hood, roof, and/or rear trunk or boot area.

### BACKGROUND OF INVENTION

The burning of gasoline, diesel, and other fossil fuels has presented recurring problems for automobiles. At various times especially during petroleum shortages the price of gasoline and other liquid fossil fuels has skyrocketed causing concern for those that use fossil feels for transportation to work and for pleasurable pursuits. For this reason there has been great efforts by automobile industry to produce automobiles that use less petroleum-based products. One approach for lessening the use of petroleum-based products is the use of all electric or hybrid electric gasoline powered cars. That is automobiles with batteries that could either totally power the car, or assist the car during periods of high energy use such as acceleration from stop or when going up longer hills.

In recognition of this problem there has been a number of attempts to use the wind air that passes over the automobile to power generators/alternators to product electricity from air flow which airflow that would otherwise go to waste. This electricity would be stored in batteries for later use. There are two major driving conditions for producing air energy. As the automobile is slowed and stopped the energy that would be dissipated by the brakes the car is transformed into electricity to be stored in the battery. Likewise during downhill movement of automobiles adds extra momentum to the automobile which momentum is converted into electricity to be stored in the battery.

The novel aspects of the present invention is that there are two or more generators in each air hood with fans to generate electricity. Likewise there are up to three hoods/generators for the automobile, on in the front of the motor section, on the roof of the car, and one over the trunk/boot of the automobile.

### SUMMARY OF THE INVENTION

The invention is an air motion electric generator system for automobiles. Each air motion generator system comprises a hood with fans and two or more electric motors/generators operationally connected to both an electric storage battery and to a control mechanism. Control mechanism manages electric current from battery to electric generator/motors. This generator/motor is an axillary power source to move the automobile. A control mechanism manages electric current from electric motor/generator to storage battery. The electric motor/generator accelerate or decelerate the automobile through wheels and electric motor/generator generates electricity when said automobile is decelerating and this electricity is stored in battery. Driver directed device operator control mechanism to accelerate or decelerate said automobile.

The invention has one or more hoods to focus moving air. These hoods contain two or more electric producing devices powered by one or more fans. Control mechanism directs said electric current from electric producing devices to battery. Hoods are mounted on said grill area, and/or on the roof, and/or on the trunk boot part of the automobile.

### BRIEF DESCRIPTION OF FIGURES

FIG. 1 outlines the front view of invention 101.

FIG. 2 shows invention 101 with section view through fans 105 and electric producing device 107.

FIG. 3 side view of invention 101 mounted on front/grill under hood.

FIG. 4 is operational diagram of air motion electric generator system of invention 101.

### DETAILED DESCRIPTION OF FIGURES

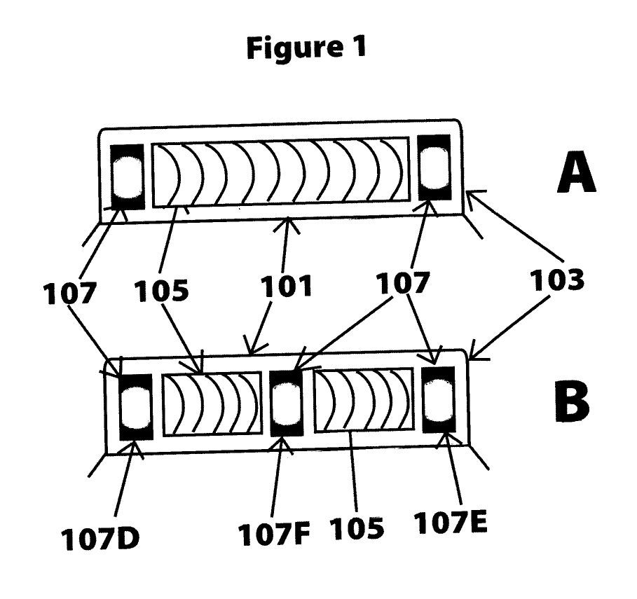

FIG. 1 outlines the front view of invention 101. Invention 101 has a hood 103 to focus moving air. Within hood 101 is affixed two or more electric producing devices 107 powered by one or more fans 105. A shows a single fan 105 with an electric producing device 107 affixed at each end. B shows fans 105 with three electric producing devices 107 D E F , electric producing devices 107 D, 107 E each on the ends of fan 105 and one electric producing device 107 F in the middle. As air flows over fans 105 electricity is produced.

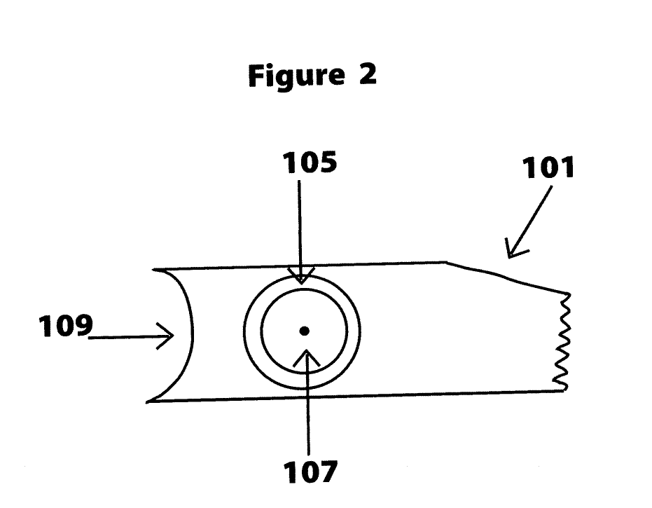

FIG. 2 shows invention 101 with section view through fans 105 and electric producing device 107. As moving air 109 passes through fan 105 fan 105 rotates producing electricity from electricity producing device 107.

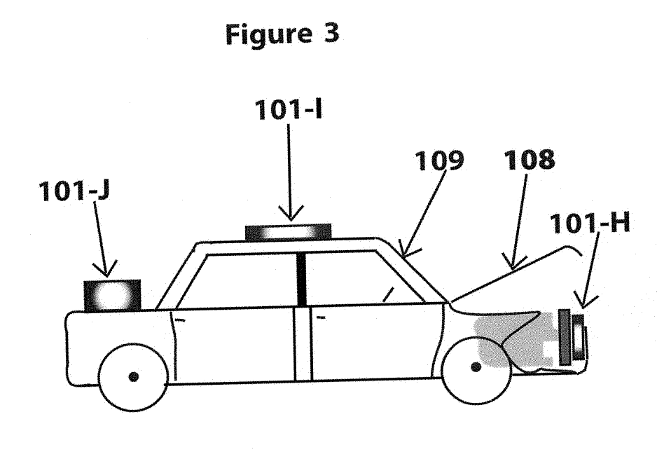

FIG. 3 side view of invention 101 mounted on front/grill 101 H under hood 108. Hood 108 is shown in open position. Likewise, invention 101 is mounted on top 101 I and trunk/rear 101 J of workpiece automobile 109.

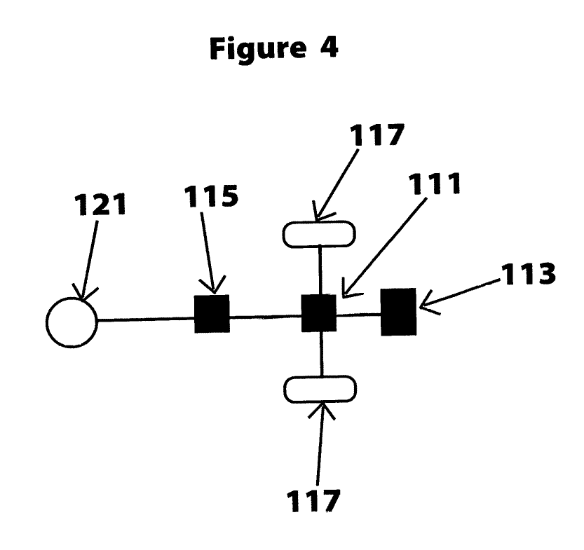

FIG. 4 is operational diagram of air motion electric generator system of invention 101. One or more electric motors/generators 111 is operationally connected to both an electric storage battery 113 and to control mechanism 115. Control mechanism 115 controls electric flow from generators 103 to storage battery 113. Control mechanism 115 manages electric current from battery 113 to electric generator/motors 111 and from electric motor/generator 111 to storage battery 113. Electric motor/generator 111 motor is an axillary power source to power the automobile 109 and accelerates or decelerates the automobile 109 through wheels 117. Electric motor/generator 111 generates electricity when said automobile is decelerating and this electricity is stored in battery 113. Driver directed device 121 manages control mechanism 109 to accelerate or decelerate workpiece automobile 109.

I claim:

1) Air motion electric generator system for automobile comprising:
one or more hoods 101 on workpiece automobile 109 to focus moving air;
said hoods 101 contains two or more electric producing devices 117 affixed to one or more fans 119;
a control mechanism 115 to direct electric current from said electric producing devices 117 to said battery 113;
said battery 113 powering said automobile 109 through electric motor/generator 111.

2) Air motion electric generator system for automobiles 101 as in claim 1 wherein one of said hoods 101 is mounted under hood grill area of said workpiece automobile 109.

3) Air motion electric generator system for automobiles 101 as in claim 1 wherein one of said hoods 101 is mounted on the roof of said automobile 109.

4) Air motion electric generator system for automobiles 109 as in claim 1 wherein one of said hoods 101 is mounted on trunk part of said automobile 109.
